(19) United States
(12) Patent Application Publication
(10) Pub. No.: US 2004/0061906 A1
(43) Pub. Date: Apr. 1, 2004

(54) Image forming apparatus and image data transmitting method

(75) Inventor: Yuji Rikima, Numazu-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/254,564

(22) Filed: Sep. 26, 2002

(51) Int. Cl. H04N 1/04; H04N 1/46

(52) U.S. Cl. 358/474; 358/505

(57) ABSTRACT

A CPU files image data inputted through a scanner according to read setting on a data table and starts processing tasks corresponding to each transmission destination for image data filed according to transmission destination setting on the data table.

### BACKGROUND OF THE INVENTION

The present invention relates to an image forming apparatus which reads an image from an original through a scanner so as to form the image and an image data transmitting method thereof.

Conventionally, a digital multi-functional peripheral and the like having a function for transmitting an image read through a scanner has been developed for an image forming apparatus in a digital copying machine or the like.

Jpn. Pat. Appln. KOKAI Publication No. 2001-313752 titled “Multi-function System and Image Data Transmitting Method for the System” has disclosed a method of transmitting image data to plural transmission destinations through the network. According to this image data transmitting method, information about the content of processing to be carried out at a transmission destination is attached to the image data and this data is broadcasted to plural transmission destinations through the network. Then, each transmission destination processes the image data according to information of the attached processing content.

However, because according to such a method, information about the content of processing to be executed at each individual transmission destination is attached to image data, there is such a problem that load on network is high.

Further, because when it is intended to transmit the data to plural transmission destinations, each individual transmission destination has to be specified and then image scanning has to be repeated, it takes labor and time for such an operation.

### BRIEF SUMMARY OF THE INVENTION

An object of the present invention is to provide an image forming apparatus in which load on the network is reduced and operability for transmission to plural destinations is improved and an image data transmitting method thereof.

In order to achieve the above object, according to one aspect of the present invention, there is provided an image forming apparatus comprising: an image reading portion which reads an image on an original; a plurality of processing portions which carry out transmission processing on image data to be read by the image reading portion corresponding to each of plural transmission destinations; a setting portion which sets the transmission destination of the image data to be read by the image reading portion; and a control portion which, when the image data read by the image reading portion is transmitted to one or plural transmission destinations set by the setting portion, controls starting of the processing portions corresponding to one or plural transmission destinations set by the setting portion in the plurality of processing portions.

According to another aspect of the present invention, there is provided an image data transmitting method of an image forming apparatus having an image reading portion which reads an image on an original for transmitting image data, the method comprising: inputting read setting for reading an image on an original through the image reading portion and transmission destination setting for the read image data; controlling reading of the image data in the image reading portion based on the inputted read setting; and when the image data read by the control is transmitted based on the inputted transmission destination setting, controlling starting of transmission processings corresponding to each of the set transmission destinations in parallel.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiment of the invention, and together with the general description given above and the detailed description of the preferred embodiment given below, serve to explain the principles of the invention.

FIG. 1 is a diagram showing an example of a system configuration of an image forming apparatus according to the present invention;

FIG. 2 is a block diagram showing a schematic configuration of the image forming apparatus;

FIG. 3 is a diagram schematically showing an example of the configuration of a whole control portion;

FIG. 4 is a diagram showing an example of the configuration of processing tasks stored in a ROM;

FIG. 5 is a diagram showing an example of a setting screen displayed on a liquid crystal display portion;

FIG. 6 is a diagram showing an example of a data table about setting values stored in a hard disc unit; and

FIG. 7 is a flow chart for explaining a processing operation when scanning is executed.

### DETAILED DESCRIPTION OF THE INVENTION

Hereinafter, an embodiment of the present invention will be described with reference to the accompanying drawings.

FIG. 1 is a diagram showing an example of a system configuration of an image forming apparatus according to the present invention. A client PC 3, an e-mail server 4, an FTP server 5 and the like are connected to an image forming apparatus 1 through a network 2.

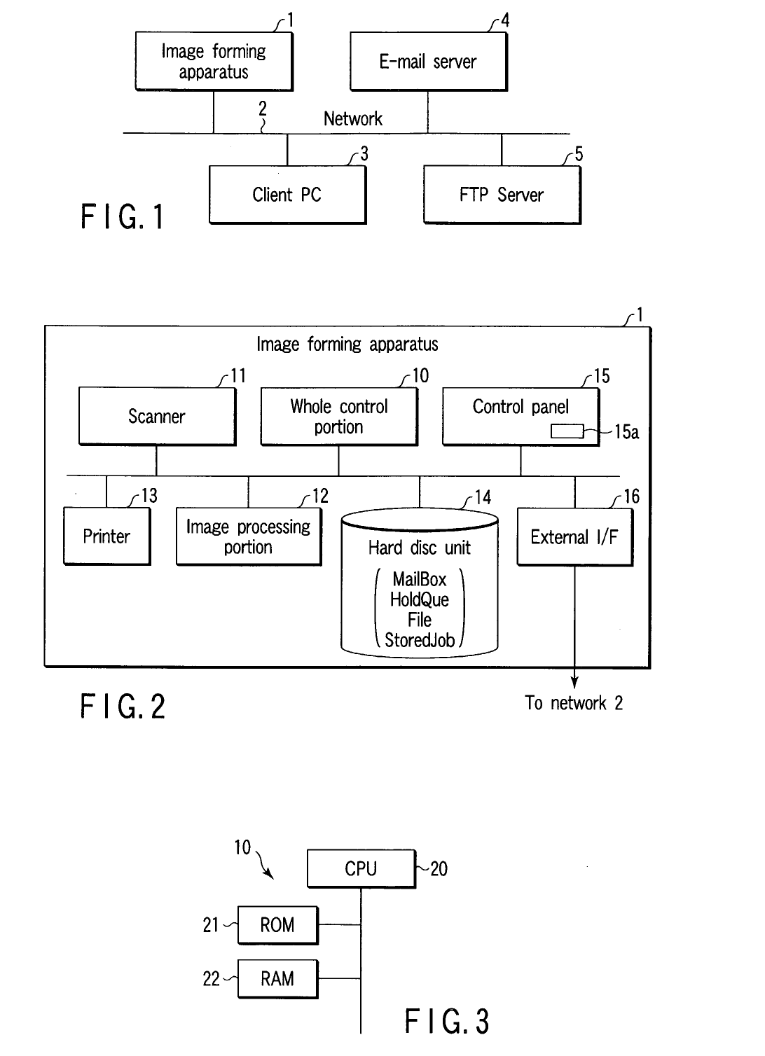

FIG. 2 shows a schematic configuration of the image forming apparatus 1. The image forming apparatus 1 comprises a whole control portion 10, a scanner 11, an image processing portion 12, a printer 13, a hard disc unit 14, a control panel 15 and an external interface (I/F) 16.

The whole control portion 10 controls the entire apparatus.

The scanner 11 scans an original by irradiating it with a light source (not shown) and reads reflection light from the original through a CCD sensor (not shown).

The image processing portion 12 carries out such processing as y correction, color conversion, main scanning variable power, image separation, remaking, area processing, gradation correction processing on image data read by the scanner 11.

The printer 13 forms an image based on image data from the image processing portion 12.

The hard disc unit 14 stores setting of transmission destinations for mail box or the like, image data and the like, which will be described in detail later.

The control panel 15 has a liquid crystal display portion 15a accommodating a touch panel, which displays various kinds of information and through which various kinds of settings of scan information or the like are inputted.

The external interface 16 is an interface for connecting to the network 2.

FIG. 3 shows an example of the configuration of the whole control portion. The whole control portion 10 comprises a CPU 20 for controlling the entire system, a ROM 21 for storing various kinds of tasks, which will be described in detail later, and a RAM 22 for storing data temporarily.

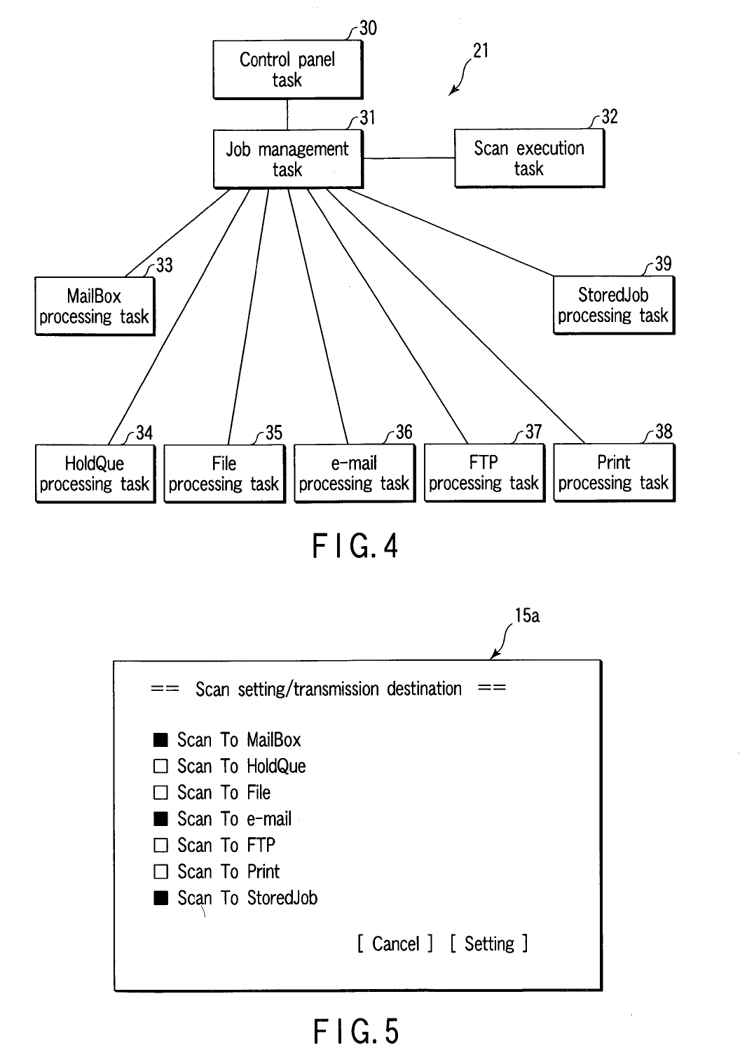

FIG. 4 shows an example of the configuration of processing tasks stored in the ROM 21. The tasks stored in the ROM 21 include control panel task 30, Job management task 31, scan execution task 32, MailBox processing task 33, HoldQue processing task 34, File processing task 35, e-mail processing task 36, FTP processing task 37, Print processing task 38 and storedJob processing task 39.

The control panel task 30 transfers scan information set through the control panel 15 to the Job management task 31.

The Job management task 31 calls the scan execution task 32 so as to input and file image data, and then calls each processing task (33-39) for each set transmission destination. At this time, the Job management task 31 carries out each processing task of the filed image data for each transmission destination in parallel.

The MailBox processing task 33 is started when a set transmission destination is MailBox.

The HoldQue processing task 34 is started when a set transmission destination is HoldQue.

The File processing task 35 is started when a set transmission destination is File.

The e-mail processing task 36 is started when a set transmission destination is e-mail.

The FTP processing task 37 is started when a set transmission destination is FTP (file transfer protocol).

The Print processing task 38 is started when a set transmission destination is Print.

The StoredJob processing task 39 is started when a set transmission destination is StoredJob.

FIG. 5 shows an example of a setting screen for “scan/transmission destination” displayed on the liquid crystal display portion 15a of the control panel 15.

When an original is scanned, following three transmission destinations, that is, “Scan To MailBox”, “Scan To e-mail”, “Scan To StoredJob”, are set as indicated in the same figure.

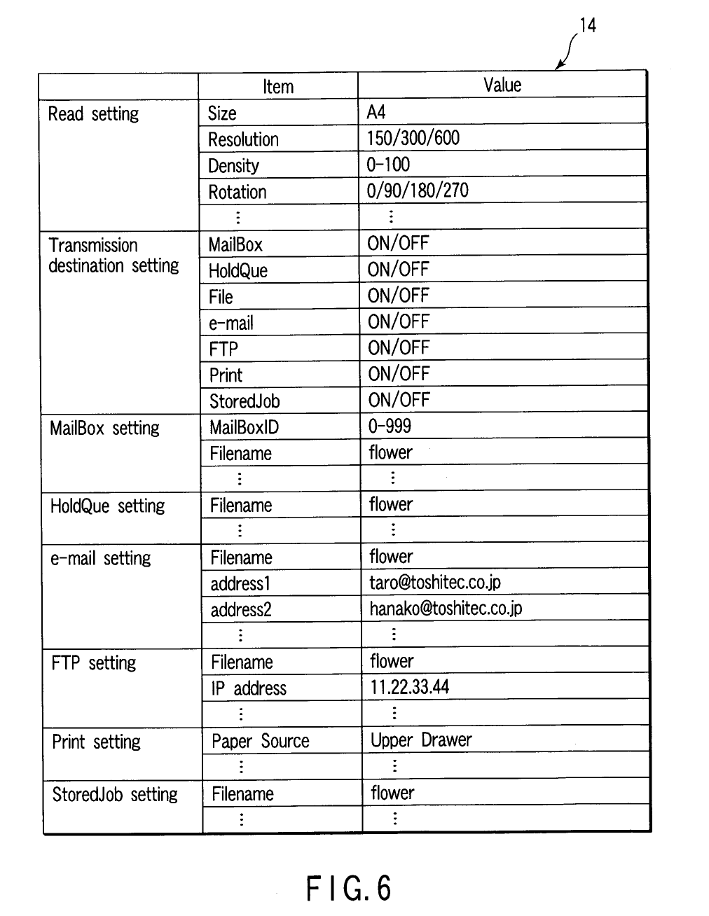

FIG. 6 shows an example of a data table about set values stored in the hard disc unit 14.

As for read setting operation, size, resolution, density, rotation, and respective values are set up. For example, as the item “size”, A4 size paper is set as “A4”.

As for transmission destination setting, ON or OFF about MailBox, HoldQue, File, e-mail, FTP, Print, StoredJob and the like is set.

If MailBox is set up, MailBox ID, Filename and the like are set as its item and “0-999”, “flower” and the like are set up as its value.

If e-mail is set up, Filename, address1, address2 or the like is set as its item and “flower”, “taro@hoshitec.co.jp”, “hanako@toshitec.co.jp” or the like is set as its value.

If FTP is set up, Filename, IP address or the like is set as its item and “flower”, “11.22.33.44” or the like is set as its value.

If Print is set up, PaperSource or the like is set as its item and UpperDrawer or the like is set as its value.

If StoredJob is set up, Filename or the like is set as its item and “flower” is set as its value.

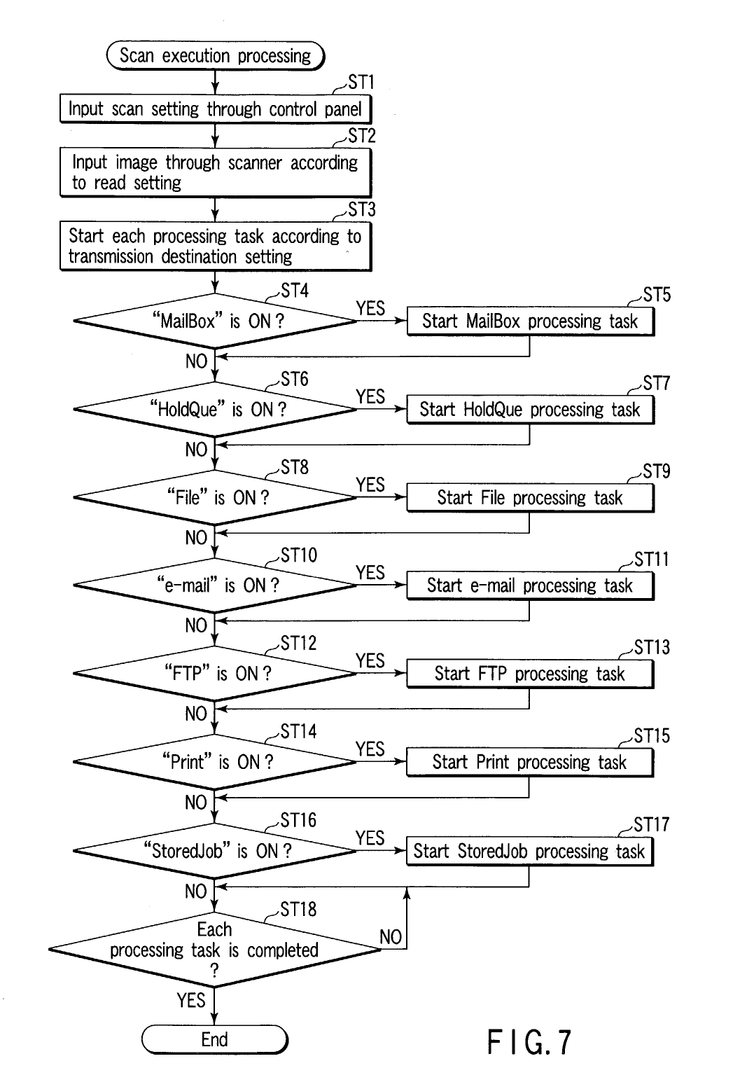

Next, the processing operation for scanning with such a structure will be described with reference to a flow chart shown in FIG. 7.

When executing scanning, first, setting of scan information is inputted through the control panel 15 (ST1). At this time, such a transmission destination as MailBox, HoldQue, File, e-mail, FTP, Print, StoredJob is set up as shown in FIG. 5 and the data table shown in FIG. 6 is stored in the hard disc unit 14.

The CPU 20 of the whole control portion 10 inputs image data through the scanner 11 according to the read setting of the data table stored in the hard disc unit 14 and files it (ST2).

Then, the CPU 20 starts processing task for a transmission destination of the filed image data according to setting of the transmission destination of the data table stored in the hard disc unit 14 (ST3).

The CPU 20 recognizes whether the item “MailBox” for setting the transmission destination is ON or OFF (ST4) and if it is ON, the CPU 20 starts the MailBox processing task 33 (ST5) and then, the processing proceeds to a next step (ST6). If it is OFF, the processing proceeds to step ST6.

Subsequently, the CPU 20 recognizes whether the item “HoldQue” for setting the transmission destination is ON or OFF (ST6) and if it is ON, the CPU starts the HoldQue processing task 34 (ST7) and then, the processing proceeds to a next step (ST8). Alternatively, if it is OFF, the processing proceeds to step ST8.

Then, the CPU 20 recognizes whether the item “File” for setting of the transmission destination is ON or OFF (ST8) and if it is ON, the File processing task 35 is started (ST9) and then, the processing proceeds to a next step (ST10). Alternatively, if it is OFF, the processing proceeds to step ST10.

The CPU 20 then recognizes whether the item “E-mail” for setting of the transmission destination is ON or OFF (ST10) and if it is ON, the e-mail processing task 36 is started (ST11) and then, the processing proceeds to a next step (ST12). Alternatively, if it is OFF, the processing proceeds to step ST12.

Subsequently, the CPU 20 recognizes whether the item “FTP” for setting of the transmission destination is ON or OFF (ST12) and if it is ON, the FTP processing task 37 is started (ST13) and then, the processing proceeds to a next step (ST14). Alternatively, if it is OFF, the processing proceeds to step ST14.

Next, the CPU 20 recognizes whether the item “Print” for setting of the transmission destination is ON or OFF (ST14) and if it is ON, the Print processing task 38 is started (ST15) and then, the processing proceeds to a next step (ST16). If it is OFF, the processing proceeds to step ST16.

Then, the CPU 20 recognizes whether the item “StoredJob” for setting of the transmission destination is ON or OFF (ST16) and if it is ON, the StoredJob processing task 39 is started (ST17) and then, the processing proceeds to a next step (ST18). Alternatively, if it is OFF, the processing proceeds to step ST18.

In step ST18, the CPU 20 recognizes whether or not all started processing tasks are completed and if all the processings are completed, the procedure is terminated.

In the meantime, the CPU 20 executes the respective started processing tasks in parallel. Therefore, if the data table shown in FIG. 6 is set up, transmission to plural destinations is enabled with a single operation.

According to the above-described embodiments of the present invention, arbitrary plural destinations can be specified as the transmission destination, so that labor and time is saved thereby improving operability.

Further, because image data processings for the plural destinations are carried out in parallel in the image forming apparatus, load for the image data processing is not applied to the network.

As for transmission of image data out of the image forming apparatus, the processed image data is outputted.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
an image reading portion which reads an image on an original;
a plurality of processing portions which carry out transmission processing on image data to be read by the image reading portion corresponding to each of plural transmission destinations;
a setting portion which sets the transmission destination of the image data to be read by the image reading portion; and
a control portion which, when the image data read by the image reading portion is transmitted to one or plural transmission destinations set by the setting portion, controls starting of the processing portions corresponding to one or plural transmission destinations set by the setting portion in said plurality of processing portions.

2. The image forming apparatus according to claim 1, wherein said plurality of processing portions are constituted of a plurality of processing tasks for carrying out transmission processing corresponding to each transmission destination.

3. The image forming apparatus according to claim 1, wherein the control portion, when all processings for the respective processing portions started in parallel are completed, terminates a sequence of the operations described above.

4. The image forming apparatus according to claim 1, wherein the control portion files image data read by the image reading portion.

5. An image forming apparatus comprising:
an image reading portion which reads an image on an original;
a plurality of processing portions which carry out transmission processing on image data to be read by the image reading portion corresponding to each of plural transmission destinations;
an input portion which inputs read setting for reading an image on an original through the image reading portion and transmission destination setting for the read image data;
a first control portion which controls reading of image data in the image reading portion based on the read setting inputted through the input portion;
a second control portion which, when image data read under the control of the first control portion is transmitted based on the transmission destination setting inputted through the input portion, starts in parallel a processing portion corresponding to each of the set transmission destinations, of said plurality of processing portions; and
a third control portion which, when transmission processings of all processing portions started under the control of the second control portion are terminated, terminates the setting inputted through the input portion.

6. An image data transmitting method of an image forming apparatus having an image reading portion which reads an image on an original for transmitting image data, the method comprising:
inputting read setting for reading an image on an original through the image reading portion and transmission destination setting for the read image data;
controlling reading of the image data in the image reading portion based on the inputted read setting; and
when the image data read by the control is transmitted based on the inputted transmission destination setting, controlling starting of transmission processings corresponding to each of the set transmission destinations in parallel.
